(19) United States
(12) Patent Application Publication
(10) Pub. No.: US 2019/0369803 A1
(43) Pub. Date: Dec. 5, 2019

(54) METHOD OF DETECTING LIQUID ON A CAPACITIVE TOUCHPAD AND CONTROLLER THEREOF

(71) Applicant: ELAN MICROELECTRONICS CORPORATION, Hsinchu (TW)

(72) Inventors: Tung-Ming Yang, Taoyuan City (TW); Hsueh-Wei Yang, Zhubei City (TW); Tien-Wen Pao, Zhubei City (TW)

(73) Assignee: ELAN MICROELECTRONICS CORPORATION, Hsinchu (TW)

(21) Appl. No.: 16/417,841

(22) Filed: May 21, 2019

Related U.S. Application Data
(60) Provisional application No. 62/680,591, filed on Jun. 5, 2018.

(30) Foreign Application Priority Data
Sep. 17, 2018 (TW) 107132695

(51) Int. Cl. G06F 3/041; G06F 3/044

(52) U.S. Cl. CPC G06F 3/0418; G06F 3/041662; G06F 3/0446

(57) ABSTRACT

A method of detecting liquid on a capacitive touchpad and controller thereof are provided. The capacitive touchpad has multiple first sensing electrodes and multiple second sensing electrodes to form multiple sensing points located at crossings of the first electrodes and the second electrodes. The method has steps of: (a) obtaining first sensing information by performing a self-capacitance measurement to the first sensing electrodes, wherein the first sensing information comprises a first sensing value of each first sensing electrode; (b) obtaining a second sensing value of each sensing point by performing a mutual-capacitance measurement to the multiple sensing points; (c) obtaining second sensing information by respectively accumulating the second sensing values of the sensing points corresponding to each first sensing electrode; and (d) determining whether liquid is present on the capacitive touchpad.

### CROSS-REFERENCE TO RELATED APPLICATIONS

This application claims the benefit of United States provisional application filed on Jun. 5, 2018 and having application Ser. No. 62/680,591, the entire contents of which are hereby incorporated herein by reference.

This application is based upon and claims priority under 35 U.S.C. 119 from Taiwan Patent Application No. 107132695 filed on Sep. 17, 2018, which is hereby specifically incorporated herein by this reference thereto.

### BACKGROUND OF THE INVENTION

### 1. Field of the Invention

The present invention relates to an object detection method for a capacitive touchpad, specifically related to a method of detecting liquid on a capacitive touchpad and controller thereof.

### 2. Description of the Prior Arts

Touch information of a capacitive touchpad, such as a type of touch object, is determined according to change in capacitance. When a liquid (for example water) is present on the capacitive touchpad and is touched by a user's finger, a conventional touch controller is not able to identify the liquid.

To overcome the shortcomings, the present invention provides a method of detecting liquid on a capacitive touchpad and a controller thereof to mitigate or obviate the aforementioned problems.

### SUMMARY OF THE INVENTION

An objective of the present invention provides a method of detecting liquid on a capacitive touchpad and a controller thereof.

According to an embodiment of the present invention, the capacitive touchpad comprises multiple first sensing electrodes and multiple second sensing electrodes to form multiple sensing points located at crossings of the first electrodes and the second electrodes. The method of detecting the liquid on the capacitive touchpad, wherein the method comprises steps of:

(a) obtaining first sensing information by performing a self-capacitance measurement to the first sensing electrodes, wherein the first sensing information comprises a first sensing value of each first sensing electrode;

(b) obtaining a second sensing value of each sensing point by performing a mutual-capacitance measurement to the multiple sensing points;

(c) obtaining second sensing information by respectively accumulating the second sensing values of the sensing points corresponding to each first sensing electrode; and

(d) determining whether liquid is present on the capacitive touchpad according to the first sensing information and the second sensing information. According to another embodiment of the present invention, a controller is adapted to determine whether liquid is present on a capacitive touchpad. The capacitive touchpad comprises multiple first sensing electrodes and multiple second sensing electrodes to form multiple sensing points located at crossings of the first electrodes and the second electrodes. The controller comprises:

a storage medium adapted to store a firmware program; and

a processor coupled to the storage medium and executing the firmware program to execute following steps of:

(a) obtaining first sensing information by performing a self-capacitance measurement to the first sensing electrodes, wherein the first sensing information comprises a first sensing value of each first sensing electrode;

(b) obtaining a second sensing value of each sensing point by performing a mutual-capacitance measurement to the multiple sensing points;

(c) obtaining second sensing information by respectively accumulating the second sensing values of the sensing points corresponding to each first sensing electrodes; and

(d) determining whether liquid is present on the capacitive touchpad according to the first sensing information and the second sensing information.

According to another embodiment of the present invention, a capacitive touchpad has multiple first sensing electrodes in X direction and multiple second sensing electrodes in Y direction to form multiple sensing points located at crossings of the first electrodes and the second electrodes. The method of detecting liquid on the capacitive touchpad comprises steps of:

(a) obtaining first X-axis sensing information and first Y-axis sensing information by performing a self-capacitance measurement to the first sensing electrodes and the second sensing electrodes, wherein the first X-axis sensing information comprises a first sensing value of each first sensing electrode and the first Y-axis sensing information comprises a first sensing value of each first Y-axis sensing electrode;

(b) obtaining a second sensing value of each sensing point by performing a mutual-capacitance measurement to the multiple sensing points;

(c) obtaining second X-axis sensing information by respectively accumulating the second sensing values of the sensing points corresponding to each first sensing electrodes and obtaining second Y-axis sensing information by respectively accumulating the second sensing values of the sensing points corresponding to each second sensing electrodes; and

(d) determining whether the liquid is present on the capacitive touchpad according to the first X-axis sensing information, the first Y-axis sensing information, the second X-axis sensing information and the second Y-axis sensing information.

By the method and the controller according to the present invention, liquid on the capacitive touchpad can be identified.

Other objectives, advantages and novel features of the invention will become more apparent from the following detailed description when taken in conjunction with the accompanying drawings.

### BRIEF DESCRIPTION OF THE DRAWINGS

FIG. 1 is a system schematic view of a capacitive touchpad in accordance with the present invention;

FIG. 2A is a flowchart of liquid detection method for a capacitive touchpad in accordance with the present invention;

FIG. 2B is a flowchart of an embodiment of step S40 of FIG. 2A;

FIG. 3 is a schematic chart showing first X-axis sensing information and first Y-axis sensing information of the capacitive touchpad;

FIG. 4A is a schematic chart showing a second sensing value of each sensing point of the capacitive touchpad;

FIG. 4B is a schematic chart showing second X-axis sensing information and second Y-axis sensing information of the capacitive touchpad;

FIG. 4C is a schematic chart showing third X-axis sensing information and third Y-axis sensing information of the capacitive touchpad;

FIG. 4D is a schematic chart showing X-axis difference information and Y-axis difference information of the capacitive touchpad;

FIG. 5 is a functional block diagram of a controller of FIG. 1.

FIG. 6 is a block diagram of an embodiment of a sensing unit of FIG. 5; and

FIGS. 7A to 7D are signal waveform diagrams showing driving signals and sensing time used in the self-capacitance measurement and the mutual-capacitance measurement.

### DETAILED DESCRIPTION OF THE EMBODIMENTS

Several embodiments are provided in following descriptions to explain the concept of the present invention. Please note the components in each embodiment can be implemented by hardware (e.g. circuit or device), and can implemented by firmware

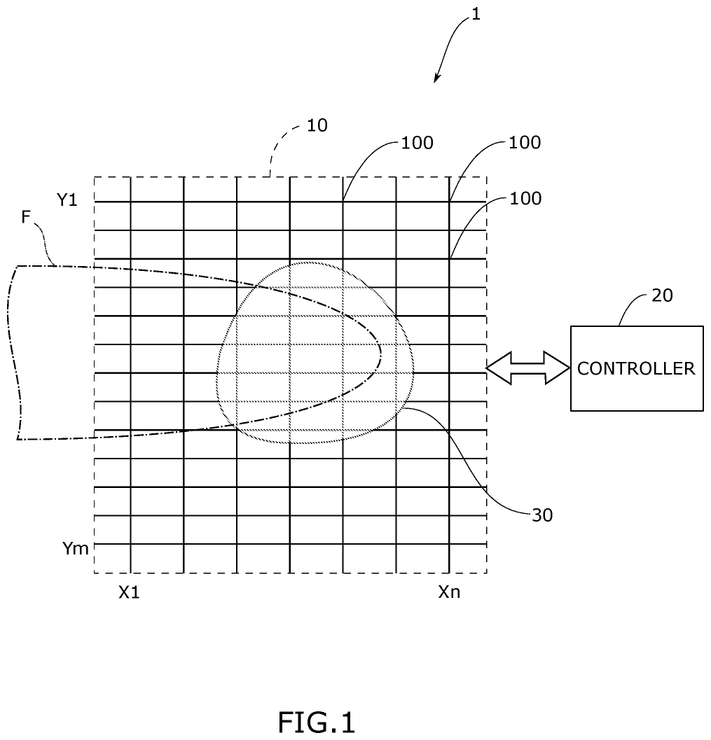

With reference to FIG. 1, a capacitive touch sensing device 1 has a capacitive touchpad 10 and a controller 20. The capacitive touchpad 10 may be transparent or non-transparent. The capacitive touchpad 10 comprises multiple sensing electrodes X1˜Xn in X direction and multiple sensing electrodes Y1˜Ym in Y direction to form multiple sensing points located at crossings of the sensing electrodes X1˜Xn and the sensing electrodes Y1˜Ym. In FIG. 1, the positions of the sensing electrodes X1˜Xn in X direction and the positions of the sensing electrodes Y1˜Ym are only schematic but are not intended to limit the claimed scope of the present invention. The controller 20 is coupled to the capacitive touchpad 10. The controller 20 is configured to detect sensing values of the sensing electrodes X1˜Xn, the sensing electrodes Y1˜Ym and the sensing points 100. There is liquid (for example water) labeled by a referenced number “30” on the capacitive touchpad 10. A conductive object (for example a finger F) touches the liquid 30 so that the liquid is electrically connected to ground.

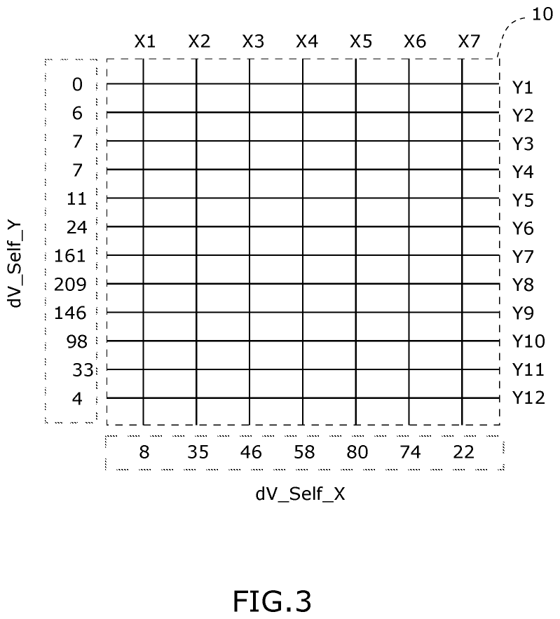

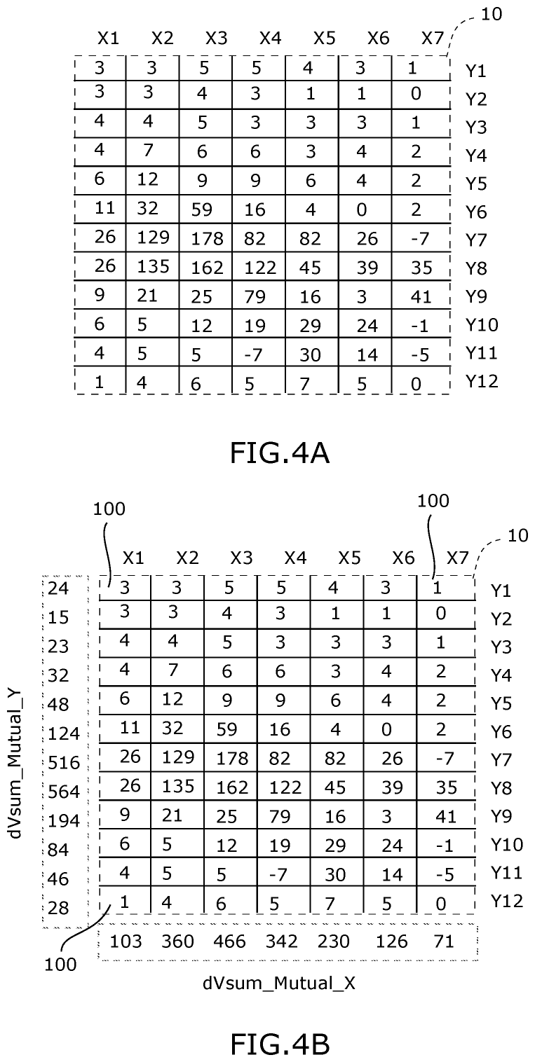

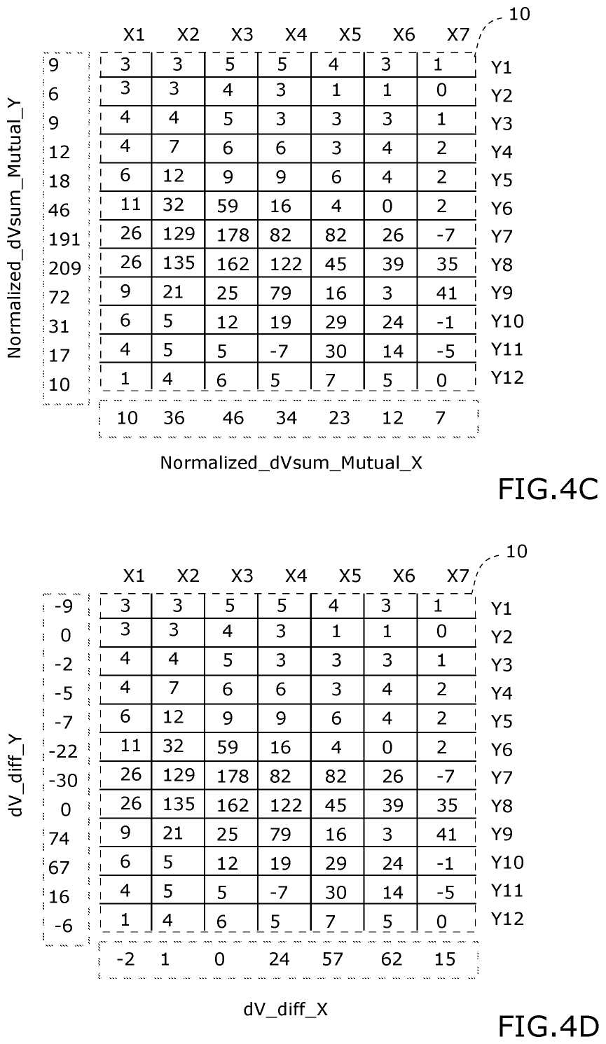

To conveniently describe the present invention, in the embodiments shown in FIGS. 3 and 4A to 4D, the capacitive touchpad has seven first sensing electrodes X1˜X7 in X direction and twelve second sensing electrodes Y1˜Y12 in Y direction. Eighty-four sensing points are formed at crossings of the first sensing electrodes X1˜X7 and the second sensing electrodes Y1˜Y12.

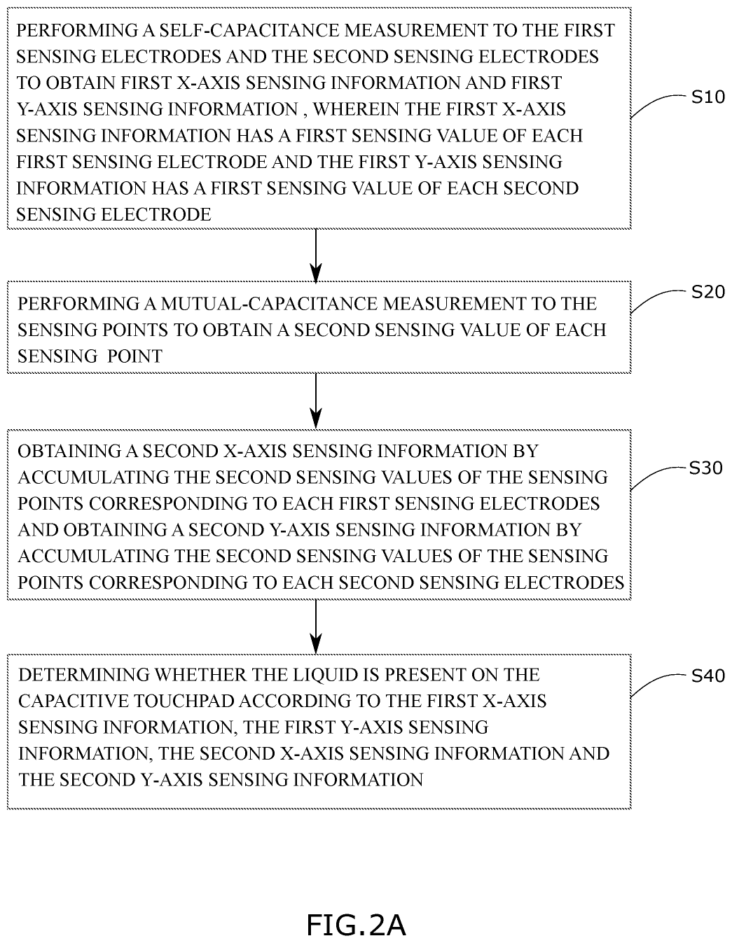

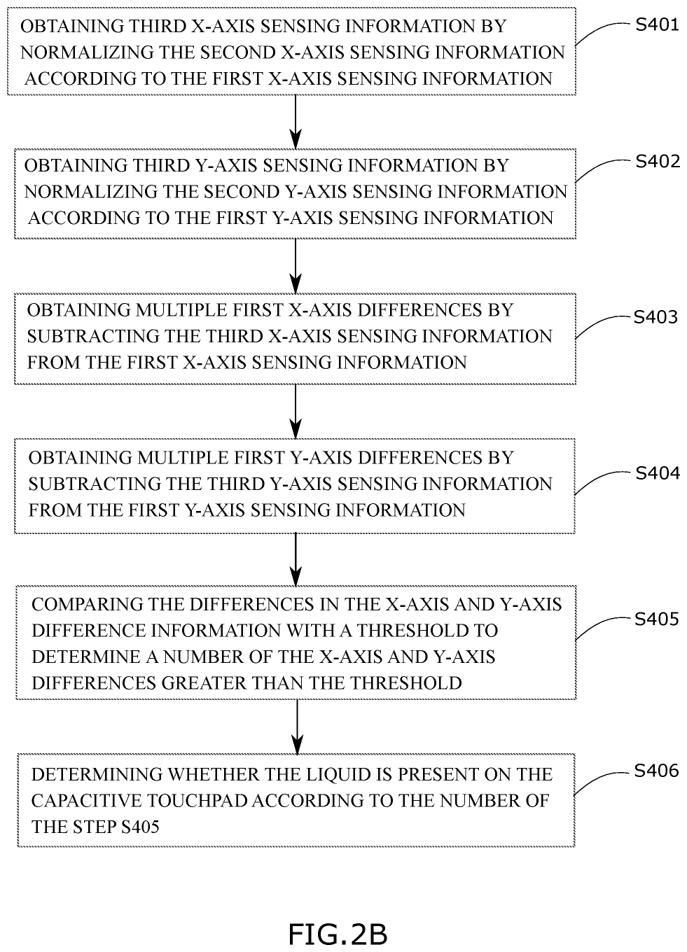

With further reference to FIG. 2A, a flowchart of a liquid detection method of the capacitive touchpad 10 according to the present invention is shown. The liquid detection method has following steps S10˜S40.

In the step S10, the controller performs a self-capacitance measurement to the first sensing electrodes X1˜X7 in the X direction and the second sensing electrodes Y1˜Y12 in the Y direction to obtain first X-axis sensing information dV_Self_X and first Y-axis sensing information dV_Self_Y as shown in FIG. 3. The first X-axis sensing information dV_Self_X has a first sensing value of each of the first sensing electrodes X1˜X7. As shown in FIG. 3, the first sensing value of the first sensing electrode X1 is “8” and the first sensing value of the first sensing electrode X7 is “22”. The first Y-axis sensing information dV_Self_Y has the first sensing value of each of the second sensing electrodes Y1˜Y12. As shown in FIG. 3, the first sensing value of the second sensing electrode Y1 is “0” and the first sensing value of the second sensing electrode Y12 is “4”,

The self-capacitance measurement mentioned above comprises simultaneously driving multiple sensing electrodes. In an embodiment, when driving and reading one of the first and second sensing electrodes, the controller 20 also outputs driving signal with the same phase to the first or second sensing electrode adjacent to the driven first or second sensing electrode. For example, when measuring the first sensing value of the first sensing electrode X3, the controller 20 outputs the driving signal to the first sensing electrode X3 and two first sensing electrodes X2 and X4 adjacent to the first sensing electrode X3. When measuring the first sensing value of the second sensing electrode Y3, the controller 20 outputs the driving signal to the first sensing electrode X3 and two second sensing electrodes Y2 and Y4 adjacent to the second sensing electrode Y3.

In another embodiment, the self-capacitance measurement comprises providing the driving signal to all of the first sensing electrodes X1˜X7 at the same time and then receive multiple signals of the first sensing electrodes X1˜X7, and providing driving signal with the same phase to all of the second sensing electrodes Y1˜Y12 at the same time and then receive multiple signals of the second sensing electrodes Y1˜Y12.

In the step S20, the controller 20 performs the mutual-capacitance measurement to the multiple sensing points 100 to obtain multiple second sensing values of the sensing points 100 as shown in FIG. 4A. In FIG. 4A, the second sensing value of the sensing point 100 formed between the first sensing electrode X1 and the second sensing electrodes Y1 is “3” and the second sensing value of the sensing point 100 formed between the first sensing electrode X3 and the second sensing electrodes Y7 is “178”. The details of mutual-capacitance measurement are well known by those skilled in the art, and are omitted herein for brevity. The sequence of the step S10 and the step S20 may be exchanged. In another embodiment, the step S20 is executed before the step S10.

After the second sensing values of the sensing points 100 are obtained, the step S30 is proceeded. In the step S30, second X-axis sensing information dVsum_Mutual_X is obtained by respectively calculate a sum of the second sensing values of the sensing points 100 corresponding to each of the first sensing electrodes X1˜X7, and second Y-axis sensing information dVsum_Mutual_Y is obtained by respectively calculate a sum of the second sensing values of the sensing points 100 corresponding to each of the second sensing electrodes Y1˜Y1. FIG. 4B shows the second X-axis sensing information dVsum_Mutual_X and the second Y-axis sensing information dVsum_Mutual_Y. Each of the first sensing electrodes X1˜X7 and the second sensing electrodes Y1˜Y12 corresponds to one accumulated sensing value. For example, in FIG. 4B, there are twelve sensing points 100 corresponding to the first sensing electrode X1 and the sum of the second sensing values of the twelve sensing points 100 is “103”. There are seven sensing pints 100 corresponding to the second sensing electrode Y1 and the sum of the second sensing values of the seven sensing points 100 is “24”.

Step S40 is to determine whether liquid is present on the capacitive touchpad 10 according to the first X-axis sensing information dV_Self_X, the second X-axis sensing information dVsum_Mutual_X, the first Y-axis sensing information dV_Self_Y and the second Y-axis sensing information dVsum_Mutual_Y.

One embodiment of the step S40 comprises determining an X-axis difference information dV_diff_X according to the first X-axis sensing information dV_Self_X and the second X-axis sensing information dVsum_Mutual_X, determining Y-axis difference information dV_diff_Y according to the first Y-axis sensing information dV_Self_Y and the second Y-axis sensing information dVsum_Mutual_Y and determining whether the liquid is present on the capacitive touchpad 10 according to the X-axis difference information dV_diff_X and/or the Y-axis difference information dV_diff_Y. More details of the step S40 are shown in FIG. 2B.

In the step S401, third X-axis sensing information Normalized_dVsum_Mutual_X is obtained by normalizing the second X-axis sensing information dVsum_Mutual_X according to the first X-axis sensing information dV_Self_X. In an embodiment of step S401, the third X-axis sensing information Normalized_dVsum_Mutual_X shown in FIG. 4C is obtained by normalizing the second X-axis sensing information dVsum_Mutual_X according to the first sensing value “46” of the first sensing electrode X3 corresponding to the maximum value “466” in the second X-axis sensing information dVsum_Mutual_X. In the normalization, each value of the second X-axis sensing information dVsum_Mutual_X is multiplied by a ratio 46/466, wherein the denominator “466” of the ratio is the maximum value in the second X-axis sensing information dVsum_Mutual_X corresponding to the first sensing electrode X3 and the molecule “46” of the ratio is the first sensing value of the first sensing electrode X3.

In the step S402, third Y-axis sensing information Normalized_dVsum_Mutual_Y is obtained by normalizing the second Y-axis sensing information dVsum_Mutual_Y according to the first Y-axis sensing information dV_Self_Y. In an embodiment of step S402, the third Y-axis sensing information Normalized_dVsum_Mutual_Y shown in FIG. 4C is obtained by normalizing the second Y-axis sensing information dVsum_Mutual_Y according to the first sensing value “209” of the second sensing electrode Y8 corresponding to the maximum value “564” in the second Y-axis sensing information dVsum_Mutual_Y. In the normalization, each value of the second Y-axis sensing information dVsum_Mutual_Y is multiplied by a ratio 209/564, wherein the denominator “564” of the ratio is the maximum value in the second Y-axis sensing information dVsum_Mutual_Y corresponding to the second sensing electrode Y8 and the molecule “209” of the ratio is the first sensing value of the second sensing electrode Y8.

In the step S403, X-axis difference information comprising multiple X-axis differences is obtained by subtracting the third X-axis sensing information Normalized_dVsum_Mutual_X from the first X-axis sensing information dV_Self_X. The multiple X-axis differences are shown in X-axis difference information dV_diff_X of FIG. 4D. For example, the first sensing value of the first sensing electrode X3 in the first X-axis sensing information dV_Slef_X is “46” and the value corresponding to the first sensing electrode X3 in the third X-axis sensing information Normalized_dVsum_Mutual_X is “46”. By subtracting “46” from “46”, the X-axis difference corresponding to the first sensing electrode X3 is “0” as show in in FIG. 4D.

In the act S404, Y-axis difference information comprising multiple Y-axis differences is obtained by subtracting the third Y-axis sensing information Normalized_dVsum_Mutual_Y from the first Y-axis sensing information dV_Self_Y. The multiple Y-axis differences are shown in Y-axis difference information dV_diff_Y of FIG. 4D. For example, the first sensing value of the second sensing electrode Y9 in the first Y-axis sensing information dV_Slef_Y is “146” and the value corresponding to the second sensing electrode Y9 in the third Y-axis sensing information Normalized_dVsum_Mutual_Y is “72”. By subtracting “72” from “146”, the Y-axis difference corresponding to the second sensing electrode Y3 is “74” as shown in FIG. 4D.

In the step S405, the number of the differences greater than a threshold is determined by comparing the differences in the X-axis difference information dV_diff_X and the Y-axis difference information dV_diff_Y with a threshold. If the threshold is “50”, for example, by comparing the multiple X-axis differences in the X-axis difference information dV_diff_X, the number of the X-axis differences greater than the threshold is determined as “2”, and by comparing the multiple Y-axis differences in the Y-axis difference information dV_diff_Y with “50”, the number of the Y-axis differences greater than the threshold is determined as “2”.

Step S406 is to determine whether liquid is present on the capacitive touchpad 10 according to the number of the differences greater than the threshold obtained in the step S405. In an embodiment of the step S406, when the number of the differences greater than the threshold is greater than “0” (no matter on X direction or Y direction), it is determined that liquid is present on the capacitive touchpad. According to the comparison result of the step S405, the number of the differences greater than the threshold is “4”, so that step S406 determined that liquid is present on the capacitive touchpad 10.

Changing the sequence of the above-mentioned steps is possible. Based on the foregoing embodiment, the controller 20 may determine whether liquid is present on the capacitive touchpad 10 according one of X-axis difference information and Y-axis difference information. Therefore, some steps in FIG. 2A and FIG. 2B may be omitted. For example, the controller 20 can determine that liquid is present on the capacitive touchpad according to the number of the differences in the X-axis difference information greater than the threshold “50” is “2”, and the steps of obtaining the first Y-axis sensing information in the step S10, obtaining the second Y-axis sensing information in the step S30 and obtaining the Y-axis difference information in the step S404 may be omitted.

Based on the foregoing description, it is appreciated that the present invention provides the method for detecting liquid on the capacitive touchpad. The capacitive touchpad has multiple first sensing electrodes in X direction and multiple second sensing electrodes in Y direction. Multiple sensing points are formed at crossings of the first electrodes and the second electrodes. The liquid detection method comprises:

(a) obtaining first sensing information by performing a self-capacitance measurement to the first sensing electrodes, wherein the first sensing information comprises a first sensing value of each first sensing electrode;

(b) obtaining a first sensing value of each sensing point by performing a mutual-capacitance measurement to the multiple sensing points;

(c) obtaining second sensing information by respectively accumulating the second sensing values of the sensing points corresponding to each first sensing electrode; and

(d) determining whether liquid is present on the capacitive touchpad according to the first sensing information and the second sensing information.

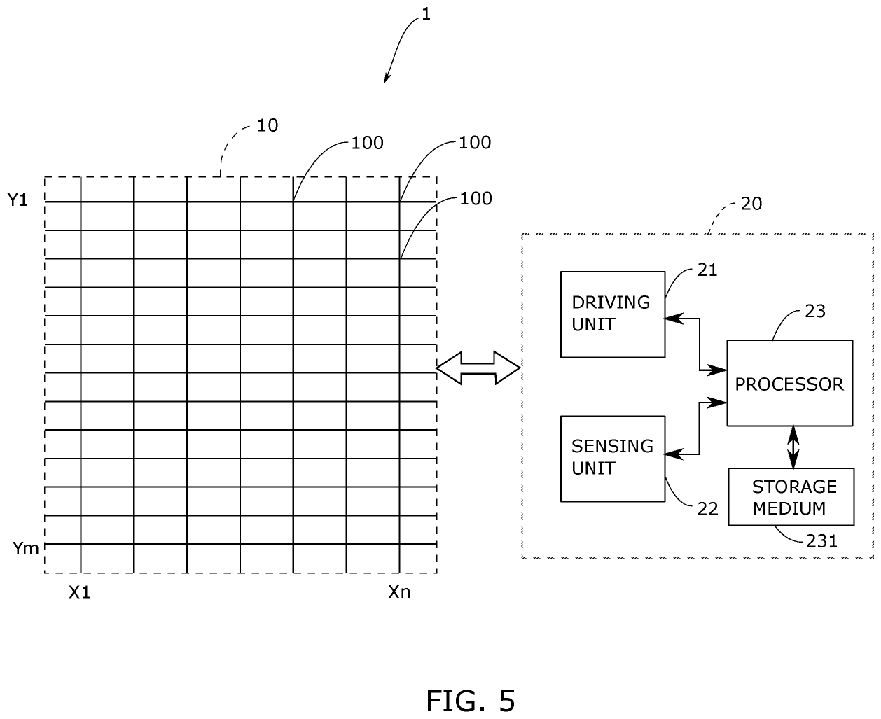

FIG. 5 shows an embodiment of the controller 20. The controller 20 has a driving unit 21, a sensing unit 22, a processor 23 and a storage medium 231. The processor 23 is coupled to the storage medium 231, the driving unit 21 and the sensing unit 22. The processor 23 executes a firmware program stored in the storage medium 231 to control operations of the driving unit 21 and the sensing unit 22 and generates touch information, such as positions or numbers of objects, according to output of the sensing unit 22. In an embodiment, the controller 20 is configured to perform self-capacitance measurement to the first sensing electrodes X1˜Xn and the second sensing electrodes Y1˜Ym and performs mutual-capacitance measurement to the multiple sensing points 100. In an embodiment of the self-capacitance measurement, the driving unit 21 provides a driving signal to the first sensing electrodes X1˜Xn and the second sensing electrodes Y1˜Ym and the sensing unit 22 senses the first sensing electrodes X1˜Xn and the second sensing electrodes Y1˜Ym to obtain the first sensing value of each of the first sensing electrodes X1˜Xn and the second sensing electrodes Y1˜Ym. In an embodiment of the mutual-capacitance measurement, the driving unit 21 provides a driving signal to the first sensing electrodes X1˜Xn in the X direction and the sensing unit 22 senses the second sensing electrodes Y1˜Ym in Y direction to obtain a second sensing value of each of the sensing points 100. The processor 23 implements the above-mentioned liquid detection method by executing the firmware program stored in the storage medium 231.

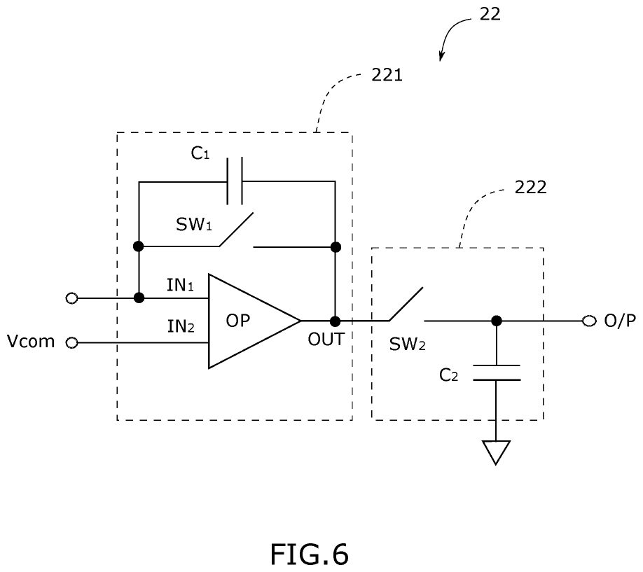

In an embodiment, the sensing unit 22 has at least one sensing circuit 221 and at least one sample and hold circuit 222. FIG. 6 shows an embodiment of the sensing circuit 221 and sample and hold circuit 222. The sensing circuit 221 has a sensing capacitor C₁, a switch SW₁ and an operational amplifier OP. The sensing capacitor C₁ is connected between a first input terminal IN₁ and an output terminal OUT of the operational amplifier OP. The switch SW₁ is connected to the sensing capacitor C₁ in parallel. The output terminal OUT of the operational amplifier OP is connected to the sample and hold circuit 222. The sample and hold circuit 222 has a switch SW₂ and a sampling capacitor C₂. The switch SW₂ is connected between the output terminal OUT of the operational amplifier OP and the sampling capacitor C₂. One end of the sampling capacitor C₂ is connected to ground and the other end of the sampling capacitor C₂ is connected to an output terminal O/P of the sample and hold circuit 222.

Following describes operation of the sensing circuit 221. In a first phase, the switch SW₁ is turned on to cause the charge amount of the sensing capacitor C₁ to be zero. In a second phase, the switch SW₁ is turned off and the switch SW₂ is turned on, and the first input terminal IN₁ of the of the operational amplifier OP is connected to a target to be sensed (such as sensing point 100, a first sensing electrode or a second sensing electrode) to perform sensing. When the switch SW₂ is turned on, the output voltage of the operational amplifier OP charges the sampling capacitor C₂. The voltage of the sampling capacitor C₂ is equal to the output voltage of the operational amplifier OP.

The voltage of the sampling capacitor C₂ is related to a time period RT that the switch SW₂ is turned on. In an embodiment, the time period RT is determined according to the time required for the output voltage of the operational amplifier OP reaches a steady state. In different embodiments, the length of time period RT may be controlled to have the switch SW₂ turned off before the output voltage of the operational amplifier OP reaches the steady state. After the switch SW₂ is turned off, the voltage value of the sampling capacitor C₂ is used to determine a sensing value.

The voltage of the sampling capacitor C₂ is converted to a digital value by an analog to digital converter (not shown). In one embodiment, the sensing value is calculated by subtracting a base value from the digital value. The base value is the output value of the analog to digital converter when no object touches the capacitive touchpad. The base values of each sensing point, each first sensing electrode and each second sensing electrode are not the same. In addition, in response to different driving signals, the base values are not the same.

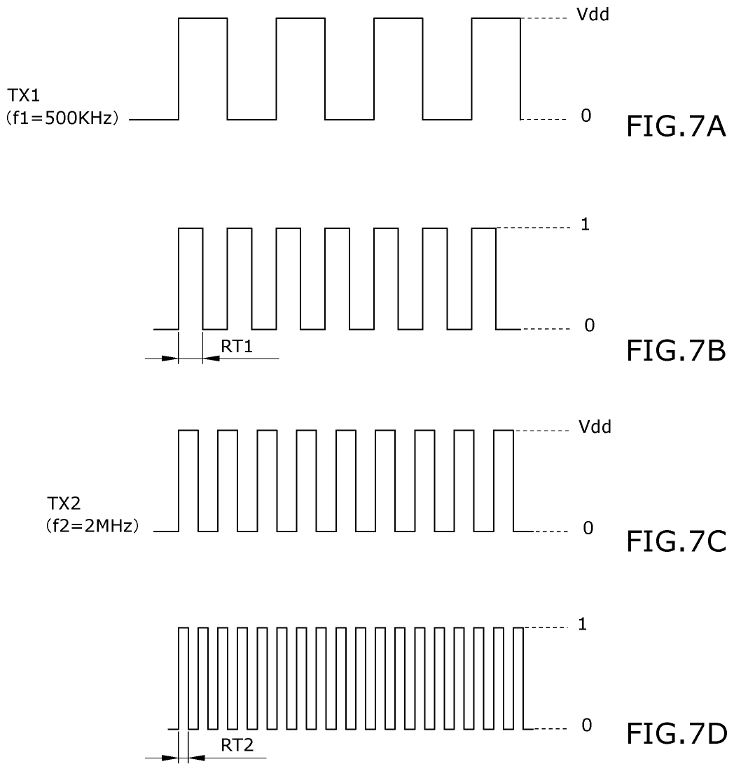

In an embodiment, in the self-capacitance measurement of the step S10, a first driving signal TX1 as shown in FIG. 7A is used and a waveform of a control signal for controlling the switch SW₂ is shown in FIG. 7B. In the mutual-capacitance measurement of the step S20, a second driving signal TX2 as shown in FIG. 7C is used and a waveform of a control signal for controlling the switch SW₂ is shown in FIG. 7D. The first driving signal TX1 has a first frequency f1. In FIG. 7A, the first frequency f1 is 500 kHz. The second driving signal TX2 has a second frequency f2. In FIG. 7C, the second frequency f2 is 2 MHz. With reference to FIGS. 7B and 7D, when the control signal is “1”, the switch SW₂ is turned on. When the control signal is “0”, the switch SW₂ is turned off. Each time the switch SW₂ turns on for a first period RT1. The first period RT1 can be understood as a time period to sense the first (or second) sensing electrode. In the first period RT1, the sensing circuit 221 senses the first or second sensing electrode. After the switch SW₂ is turned off, an output voltage of the sample and hold circuit 222 is used to calculate the sensing value. Through the above-mentioned driving and sensing procedure for the first sensing electrodes X1˜Xn and the second sensing electrodes Y1˜Ym, the first X-axis sensing information dV_Self_X and the first Y-axis sensing information dV_Self_Y are obtained. The second period RT2 can be understood as a time period to sense the sensing point 100. In the second period RT2, the sensing circuit 221 senses the sensing point 100. After the switch SW₂ is turned off, an output voltage of the sample and hold circuit 222 is used to calculate the second sensing value of the sensing point 100. Through the above-mentioned driving and sensing procedure for all sensing points 100, the second sensing values of all sensing points 100 are obtained.

In another embodiment, the first frequency f1 may be greater, equal or less than second frequency f2. The first period RT1 may be greater, equal or less than the second period RT2. In an embodiment, the second frequency f2 is 1 MHz or more, such as any frequency in the range of 1 MHz-2 MHz. The second period RT2 may be less than or equal to 0.28125 μ/s, such as between 0.28125 μ/s˜0.09375 μ/s. In general, when the frequency of the driving signal is higher, the corresponding sensing time is shorter. In the mutual-capacitance measurement, when the frequency of the second driving signal TX2 is higher or the length of the second period RT2 is shorter, a mutual sensing value caused by liquid is smaller, which resulted in a larger difference between the self-sensing value of the first or second sensing electrode and the sum of the mutual sensing values. The present invention uses this characteristic to determine whether the liquid is present on the touchpad.

In other embodiment, when it is determined that liquid is present on the capacitive touchpad, the controller 20 provides the second driving signal TX2 or another driving signal with a higher frequency to perform the mutual-capacitance measurement for the capacitive touchpad 10 and calculates a position of a touch object according to the sensing information obtained from the mutual-capacitance measurement. The above-mentioned liquid detection method is periodically executed to confirm whether there is liquid still present on the capacitive touchpad 10.

Based on foregoing description, when the finger touches the liquid on the capacitive touchpad, the method provided by the present invention can still identify the liquid.

Even though numerous characteristics and advantages of the present invention have been set forth in the foregoing description, together with the details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of detecting liquid on a capacitive touchpad, wherein the capacitive touchpad comprises multiple first sensing electrodes and multiple second sensing electrodes to form multiple sensing points located respectively at crossings of the first electrodes and the second electrodes, and the method comprises steps of:
(a) obtaining first sensing information by performing a self-capacitance measurement to the first sensing electrodes, wherein the first sensing information comprises a first sensing value of each first sensing electrode;
(b) obtaining a second sensing value of each sensing point by performing a mutual-capacitance measurement to the multiple sensing points;
(c) obtaining second sensing information by respectively accumulating the second sensing values of the sensing points corresponding to each first sensing electrode; and
(d) determining whether liquid is present on the capacitive touchpad according to the first sensing information and the second sensing information.

2. The method as claimed in claim 1, wherein the self-capacitance measurement in the step (a) comprises simultaneously driving the first sensing electrodes.

3. The method as claimed in claim 1, wherein the step (d) further comprises steps of:
(d1) obtaining third sensing information by normalizing the second sensing information according to the first sensing information;
(d2) obtaining multiple first differences by subtracting the third sensing information from the first sensing information;
(d3) comparing each of the first differences with a threshold to determine a number of the differences greater than the threshold; and
(d4) determining whether the liquid is present on the capacitive touchpad according to the number of the step (d3).

4. The method as claimed in claim 3, wherein the step of normalizing the second sensing information in the step (d1) comprises multiplying each value of the second sensing information by a ratio, wherein the denominator of the ratio is the maximum value in the second sensing information and the molecule of the ratio is the first sensing value of the first sensing electrode corresponding to the maximum value in the second sensing information.

5. The method as claimed in claim 1, wherein the mutual capacitance measurement of the step (b) comprises sensing each of the sensing points for a second period and the second period is less than or equal to 0.28125 μs.

6. The method as claimed in claim 5, wherein the step (a) comprises sensing each of the first sensing electrodes for a first period and the second period is less or equal to the first period.

7. The method as claimed in claim 1, wherein the step (b) comprises driving each of the sensing points by a second driving signal with a second frequency and the second frequency is greater than or equal to 1 MHz.

8. The method as claimed in claim 7, wherein the step (a) comprises driving each of the first sensing electrodes by a first driving signal with a first frequency and the second frequency is greater than or equal to the first frequency.

9. The method as claimed in claim 7, wherein after determining the liquid is present on the capacitive touchpad in the step (d), obtaining a position of a touch object by driving each of the sensing points with a driving signal having a frequency greater than or equal to the second frequency to perform the mutual-capacitance measurement.

10. A controller for determining liquid is present on a capacitive touchpad, wherein the capacitive touchpad comprises multiple first sensing electrodes and multiple second sensing electrodes to form multiple sensing points located at crossings of the first electrodes and the second electrodes, and the controller comprises:
a storage medium storing a firmware program; and
a processor coupled to the storage medium and executing the firmware program to execute following steps of:
(a) obtaining first sensing information by performing a self-capacitance measurement to the first sensing electrodes, wherein the first sensing information comprises a first sensing value of each first sensing electrode;
(b) obtaining a second sensing value of each sensing point by performing a mutual-capacitance measurement to the multiple sensing points;
(c) obtaining second sensing information by respectively accumulating the second sensing values of the sensing points corresponding to each first sensing electrodes; and
(d) determining whether liquid is present on the capacitive touchpad according to the first sensing information and the second sensing information.

11. The controller as claimed in claim 10, wherein the self-capacitance measurement in the step (a) comprises simultaneously driving the first sensing electrodes.

12. The controller as claimed in claim 10, wherein the step (d) further comprises steps of:
(d1) obtaining third sensing information by normalizing the second sensing information according to the first sensing information;
(d2) obtaining multiple first differences by subtracting the third sensing information from the first sensing information;
(d3) comparing each of the first differences with a threshold to determine a number of the differences greater than the threshold; and
(d4) determining whether the liquid is present on the capacitive touchpad according to the number of the step (d3).

13. The controller as claimed in claim 12, wherein the step of normalizing the second sensing information in the step (d1) comprises multiplying each value of the second sensing information by a ratio, wherein the denominator of the ratio is the maximum value in the second sensing information and the molecule of the ratio is the first sensing value of the first sensing electrode corresponding to the maximum value in the second sensing information.

14. The controller as claimed in claim 10, wherein the mutual capacitance measurement of the step (b) comprises sensing each of the sensing points for a second period and the second period is less than or equal to 0.28125 μs.

15. The controller as claimed in claim 14, wherein the step (a) comprises sensing each of the first sensing electrodes for a first period and the second period is less or equal to the first period.

16. The controller as claimed in claim 14, wherein the step (b) comprises driving each of the sensing points by a second driving signal with a second frequency and the second frequency is greater than or equal to 1 MHz.

17. The controller as claimed in claim 16, wherein the step (a) comprises driving each of the first sensing electrodes by a first driving signal with a first frequency and the second frequency is greater than or equal to the first frequency.

18. The controller as claimed in claim 16, wherein after determining the liquid is present on the capacitive touchpad in the step (d), the controller obtains a position of a touch object by driving each of the sensing points with a driving signal having a frequency greater than or equal to the second frequency to perform the mutual-capacitance measurement.

19. A method of detecting liquid on a capacitive touchpad, wherein the capacitive touchpad has multiple first sensing electrodes in X direction and multiple second sensing electrodes in Y direction to form multiple sensing points located at crossings of the first electrodes and the second electrodes, and the method comprises steps of:
(a) obtaining first X-axis sensing information and first Y-axis sensing information by performing a self-capacitance measurement to the first sensing electrodes and the second sensing electrodes, wherein the first X-axis sensing information comprises a first sensing value of each first sensing electrode and the first Y-axis sensing information comprises a first sensing value of each first Y-axis sensing electrode;
(b) obtaining a second sensing value of each sensing point by performing a mutual-capacitance measurement to the multiple sensing points;
(c) obtaining second X-axis sensing information by respectively accumulating the second sensing values of the sensing points corresponding to each first sensing electrodes and obtaining second Y-axis sensing information by respectively accumulating the second sensing values of the sensing points corresponding to each second sensing electrodes; and
(d) determining whether liquid is present on the capacitive touchpad according to the first X-axis sensing information, the first Y-axis sensing information, the second X-axis sensing information and the second Y-axis sensing information.

20. The method as claimed in claim 19, wherein the self-capacitance measurement in the step (a) comprises steps of:
(a1) simultaneously driving the first sensing electrodes; and
(a2) simultaneously driving the second sensing electrodes.

21. The method as claimed in claim 19, wherein the step (d) further comprises steps of:
(d1) obtaining third X-axis sensing information by normalizing the second X-axis sensing information according to the first X-axis sensing information, and obtaining third Y-axis sensing information by normalizing the second Y-axis sensing information according to the first Y-axis sensing information;
(d2) obtaining multiple first X-axis differences by subtracting the third X-axis sensing information from the first X-axis sensing information, and obtaining multiple first Y-axis differences by subtracting the third Y-axis sensing information from the first Y-axis sensing information;
(d3) comparing each of the first X-axis and Y-axis differences with a threshold to determine a number of the first X-axis differences and the first Y-axis differences greater than the threshold; and
(d4) determining whether the liquid is present on the capacitive touchpad according to the number in the step (d3).

22. The method as claimed in claim 21, wherein
the step of normalizing the second X-axis sensing information in the step (d1) comprises multiplying each value of the second X-axis sensing information by a first ratio, wherein the denominator of the first ratio is the maximum value in the second X-axis sensing information and the molecule of the first ratio is the first sensing value of the first sensing electrode corresponding to the maximum value in the second X-axis sensing information; and
the step of normalizing the second Y-axis sensing information in the step (d1) comprises multiplying each value of the second Y-axis sensing information by a second ratio, wherein the denominator of the second ratio is the maximum value in the second Y-axis sensing information and the molecule of the second ratio is the first sensing value of the first sensing electrode corresponding to the maximum value in the second Y-axis sensing information.

23. The method as claimed in claim 19, wherein the mutual capacitance measurement of the step (b) comprises sensing each of the sensing points for a second period and the second period is less than or equal to 0.28125 μs.

24. The method as claimed in claim 23, wherein the step (a) comprises sensing each of the first and second sensing electrodes for a first period and the second period is less or equal to the first period.

25. The method as claimed in claim 19, wherein the step (b) comprises driving each of the sensing points by a second driving signal with a second frequency and the second frequency is greater than or equal to 1 MHz.

26. The method as claimed in claim 25, wherein the step (a) comprises driving each of the first and second sensing electrodes by a first driving signal with a first frequency and the second frequency is greater than or equal to the first frequency.

27. The method as claimed in claim 25, wherein after determining the liquid is present on the capacitive touchpad in the step (d), obtaining a position of a touch object by driving each of the sensing points with a driving signal having a frequency greater than or equal to the second frequency to perform the mutual-capacitance measurement.
